(19) United States
(12) Patent Application Publication
(10) Pub. No.: US 2025/0294110 A1
(43) Pub. Date: Sep. 18, 2025

(54) CODE RECOGNITION METHOD, INSPECTION DEVICE, AND STORAGE MEDIUM

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Ikuo MOTONAGA, Kitakyushu (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/823,919

(22) Filed: Sep. 4, 2024

(30) Foreign Application Priority Data
Mar. 12, 2024 (JP) 2024-038043

(51) Int. Cl. H04N 1/60; G06T 5/20; G06T 7/00

(52) U.S. Cl. CPC H04N 1/60; G06T 5/20; G06T 7/0008; G06T 2207/20132; G06T 2207/30148

(57) ABSTRACT

According to one embodiment, a code recognition method includes: receiving a color image including a portion in which a code is inscribed; generating a first image where a first color correction is applied to the color image so as to change at least one of a ratio of RGB and a combination of HSV; generating a second image in which a first preprocessing digital filter that performs digital filter correction is applied to the first image; generating a third image in which a second color correction different from the first color correction is applied to the color image so as to change at least one of a ratio of RGB or a combination of HSV; generating a fourth image in which a second preprocessing digital filter that performs digital filter correction is applied to the third image; and performing recognition of the code using the second and the fourth images.

### CROSS-REFERENCE TO RELATED APPLICATION

This application is based upon and claims the benefit of priority from Japanese Patent Application No. 2024-038043, filed Mar. 12, 2024, the entire contents of which are incorporated herein by reference.

### FIELD

Embodiments described herein relate generally to a code recognition method, an inspection device, and a storage medium.

### BACKGROUND

For the purpose of traceability management of semiconductor products and the like, a two-dimensional code is inscribed on a package surface or a frame surface of a target product. A code reader is used as a device for reading a two-dimensional code. The code reader recognizes the two-dimensional code using the captured two-dimensional code image.

In addition, an automatic appearance inspection device is known as a device that performs quality inspection of semiconductor products and the like. The automatic appearance inspection device recognizes and captures an image of a target product, and inspects the presence or absence of abnormality of the product. The inspection result is used for traceability management of the target product.

### BRIEF DESCRIPTION OF DRAWINGS

FIG. 1 is a schematic diagram illustrating an example of a usage mode of a plurality of inspection devices according to a first embodiment.

FIG. 2 is a block diagram illustrating an example of a hardware configuration of the inspection device according to the first embodiment.

FIG. 3 is a block diagram illustrating an example of a functional configuration of the inspection device according to the first embodiment.

FIG. 4 is a diagram illustrating an example of correction data stored in a storage in the inspection device according to the first embodiment.

FIG. 5 is a flowchart illustrating an example of a code recognition method according to the first embodiment.

FIG. 6 is a diagram illustrating an example of a method of generating color-corrected images in the code recognition method according to the first embodiment.

FIG. 7 is a diagram illustrating an example of a method of generating determination images in the code recognition method according to the first embodiment.

FIG. 8 is a block diagram illustrating an example of a functional configuration of an inspection device according to a first modification of the first embodiment.

FIG. 9 is a block diagram illustrating an example of a functional configuration of an inspection device according to a second embodiment.

FIG. 10 is a flowchart illustrating an example of a code recognition method according to the second embodiment.

### DETAILED DESCRIPTION

In general, according to one embodiment, a code recognition method includes: receiving a color image including a portion in which a code is inscribed; generating a first image in which a first color correction is applied to the color image so as to change at least one of a ratio of RGB and a combination of HSV; generating a second image in which a first preprocessing digital filter that performs preprocessing digital filter correction is applied to the first image; generating a third image in which a second color correction different from the first color correction is applied to the color image so as to change at least one of a ratio of RGB or a combination of HSV; generating a fourth image in which a second preprocessing digital filter that performs preprocessing digital filter correction is applied to the third image; and performing recognition of the code using the second image and the fourth image.

### 1. First Embodiment

### 1.1 Configuration

### 1.1.1 Overall Configuration

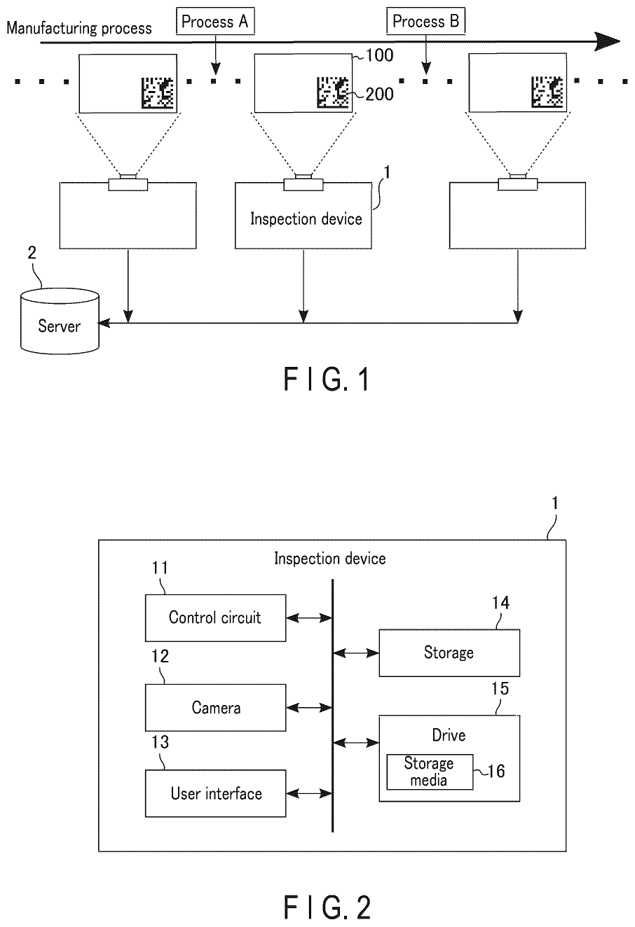

FIG. 1 is a schematic diagram illustrating an example of a usage mode of a plurality of inspection devices according to a first embodiment. The plurality of inspection devices 1 are used, for example, for automatic appearance inspection of a semiconductor product 100 and recognition of a two-dimensional code 200 inscribed on a surface of the semiconductor product 100 in the semiconductor product manufacturing lane. In the example of FIG. 1, the relationship between the plurality of inspection devices 1 and the manufacturing process of the semiconductor product 100 is illustrated.

The semiconductor product 100 is, for example, a semiconductor element constituted by a frame, a plated semiconductor component, a semiconductor package sealed with a resin, or a product in the process of manufacturing the semiconductor element, the semiconductor component, or the semiconductor package. Each side of the semiconductor product 100 has a size of about 5 mm, for example. The semiconductor product 100 has the two-dimensional code 200 on the package surface or the flame surface.

The two-dimensional code 200 is, for example, a symbol of Data Matrix. Data Matrix is a two-dimensional code symbol formed in compliance with ISO/IEC 16022 Information technology—Automatic identification and data capture techniques—Data Matrix bar code symbology specification. Data Matrix has a high information density, and it is possible to inscribe a small electronic component such as a semiconductor device. Data Matrix has, for example, a square or rectangular shape having a side of 0.8 mm or more and 15 mm or less. Hereinafter, a case where the two-dimensional code 200 is, for example, the symbol of 14×14 cells having a square shape of 1.5 mm square conforming to the standard of the ECC 200 and has data of 10 digits of alphanumeric characters will be described. The two-dimensional code 200 is inscribed on the frame surface or the resin surface of the semiconductor product 100 using a laser marker or the like having a spot diameter of about 20 μm, for example. In order to improve reliability, for example, a plurality of the same two-dimensional codes 200 may be inscribed on one semiconductor product 100.

The plurality of inspection devices 1 is provided, for example, on each of the semiconductor product manufacturing lanes. Each inspection device 1 is provided before the start of an arbitrary process, after the end of the arbitrary process, or both, and performs appearance inspection. In the appearance inspection, whether there is a defect in the semiconductor product 100 is inspected.

In addition, each inspection device 1 reads the two-dimensional code 200 simultaneously with the appearance inspection. The two-dimensional code 200 has identification information of the semiconductor product 100, such as an identification code of a product, and production information, such as a manufacturing date, a weekly code, a product number, and a machine number. The inspection device 1 associates the read identification information of the semiconductor product 100 with the result of the appearance inspection and the current process, and transmits the associated information to a server 2.

For example, each inspection device 1 reads the two-dimensional code 200 inscribed on the semiconductor product 100 before the start of the process, tracks the semiconductor product 100 during the process, and reads the two-dimensional code 200 again after the end of the process, thereby collating the semiconductor product 100. By performing the operation described in the above example, the defective state of the semiconductor product 100 and the operating state of the device used in the process are managed.

The server 2 receives data from each inspection device 1 and stores traceability information of the semiconductor product 100. The manufacturing process of the semiconductor product 100 is managed using the information stored in the server 2.

### 1.1.2 Hardware Configuration of Inspection Device

FIG. 2 is a block diagram illustrating an example of a hardware configuration of the inspection device according to the first embodiment. As illustrated in FIG. 2, the inspection device 1 includes a control circuit 11, a camera 12, a user interface 13, a storage 14, a drive 15, and a storage media 16.

The control circuit 11 is a circuit that entirely controls each component of the inspection device 1. The control circuit 11 includes a central processing unit (CPU), a random-access memory (RAM), a read-only memory (ROM), and the like. The ROM of the control circuit 11 stores programs and the like used in various processing in the inspection device 1. The CPU of the control circuit 11 controls the entire inspection device 1 according to a program stored in the ROM of the control circuit 11. The RAM of the control circuit 11 is used as a working space of the CPU of the control circuit 11.

The camera 12 is, for example, a color charge coupled devices (CCD) camera. The camera 12 captures a color image of the semiconductor product 100 to be subjected to the automatic appearance inspection. The camera 12 captures an image of the semiconductor product 100 and detects scratches and stains included in the semiconductor product 100. In order to detect fine scratches and stains, the camera 12 has a high resolution such that a high-resolution image can be captured.

The user interface 13 is an interface that manages communication between the user and the control circuit 11. The user interface 13 includes an input device and an output device. The input device includes, for example, a keyboard, a touch panel, an operation button, and the like. The output device includes, for example, a display and the like. The user interface 13 converts the input from the user into an electrical signal and then transmits the electrical signal to the control circuit 11. The user interface 13 outputs an execution result based on an input from the user to the user.

The storage 14 includes, for example, a hard disk drive (HDD) or a solid-state drive (SSD). The storage 14 stores information used in various processing in the inspection device 1.

The drive 15 is a device for reading software stored in the storage media 16. The drive 15 includes, for example, an HDD, an SSD, a compact disk (CD) drive, a digital versatile disk (DVD) drive, and the like.

The storage media 16 are some media that store software by electrical, magnetic, optical, mechanical, or chemical action. The storage media 16 may store a program for executing various processing in the inspection device 1.

### 1.1.3 Functional Configuration of Inspection Device

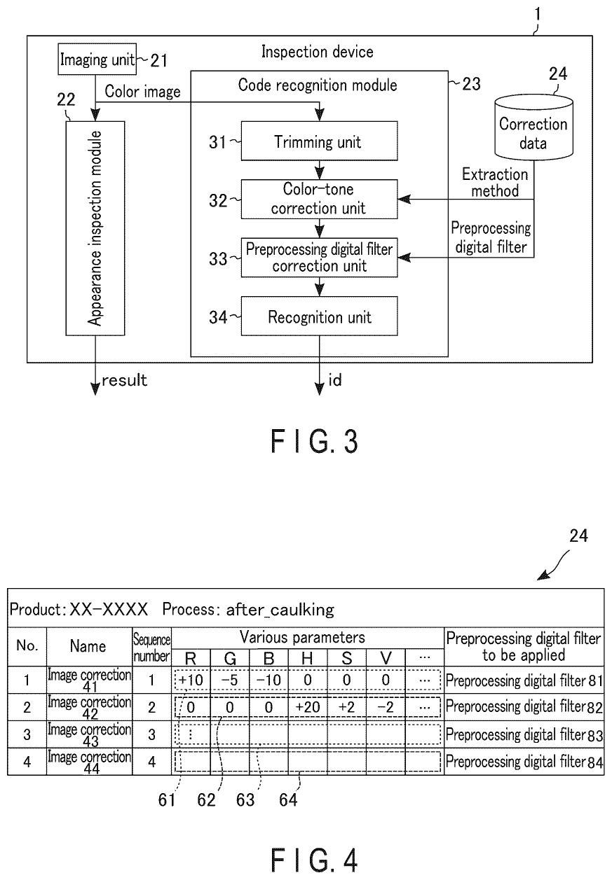

FIG. 3 is a block diagram illustrating an example of a functional configuration of the inspection device according to the first embodiment; The CPU of the control circuit 11 develops the program stored in the ROM of the control circuit 11 or the storage media 16 into the RAM of the control circuit 11. Then, the CPU of the control circuit 11 interprets and executes the program developed in the RAM of the control circuit 11. As a result, the inspection device 1 functions as a computer including an imaging unit 21, an appearance inspection module 22, and a code recognition module 23. In addition, the storage 14 stores correction data 24.

The imaging unit 21 operates the camera 12 to capture a color image of the semiconductor product 100 to be inspected. The color image of the semiconductor product 100 is captured such that the two-dimensional code 200 included in the semiconductor product 100 is included in the imaging region. The imaging unit 21 outputs the captured color image of the semiconductor product 100 to the appearance inspection module 22 and the code recognition module 23.

The appearance inspection module 22 performs appearance inspection of the semiconductor product 100 using the color image of the semiconductor product 100 received from the imaging unit 21.

Specifically, first, the appearance inspection module 22 performs processing of RGB ratio change, HSV combination change, or both on the color image of the semiconductor product 100 to generate determination images. The RGB ratio change is processing of changing individual values when hue is represented by RGB (Red/Green/Blue) values. As the RGB ratio change, for example, the red portion is changed to be redder to facilitate discrimination from the surroundings. The HSV combination change is processing of changing a combination of hue H (Hue), saturation S (Saturation), and brightness V (Value) in an image. The HSV combination change also includes a luminance change such as image smoothing or gamma correction.

Thereafter, the appearance inspection module 22 inspects whether there is a defect in the semiconductor product 100 using the generated determination images. Examples of the defect include a distortion or a crack in a product, a defect of a component, adhesion of a scratch, adhesion of a foreign substance, deviation of a circuit pattern, a dimensional defect, a defective packaging, and the like. The appearance inspection module 22 outputs an inspection result including the presence or absence of a defect to the server 2 together with identification information id to be described later.

The code recognition module 23 recognizes the two-dimensional code 200 using the color image of the semiconductor product 100 received from the imaging unit 21. The code recognition module 23 includes a trimming unit 31, a color-tone correction unit 32, a preprocessing digital filter correction unit 33, and a recognition unit 34.

The trimming unit 31 is a functional block that extracts a two-dimensional code 200 portion from the color image. When receiving the color image from the imaging unit 21, the trimming unit 31 extracts a portion including the two-dimensional code 200 from the color image and generates a trimmed image.

The color-tone correction unit 32 is a functional block that performs color correction on the trimmed image generated by the trimming unit 31. The color-tone correction unit 32 applies each of the plurality of color corrections stored in the correction data 24 to the trimmed image, and generates a plurality of color-corrected images subjected to processing of RGB ratio change, HSV combination change, or both. By performing different color corrections on one color image to generate a plurality of color-corrected images, the feature amount of the trimmed image can be decomposed for each element and extracted into each color-corrected image.

The preprocessing digital filter correction unit 33 is a functional block that preprocessing performs digital filter correction on a plurality of color-corrected images generated by the color-tone correction unit 32. The preprocessing digital filter correction unit 33 applies a preprocessing digital filter corresponding to the color correction used to generate each color-corrected image stored in the correction data 24 to each color-corrected image to generate a plurality of determination images. For each color correction, a preprocessing digital filter to be applied is determined in advance.

The recognition unit 34 is a functional block that recognizes a code. The recognition unit 34 performs code recognition processing using the plurality of determination images generated by the preprocessing digital filter correction unit 33. Thereafter, the identification information id included in the read two-dimensional code 200 is output to the server 2 together with the inspection result.

The correction data 24 includes data related to image correction applied in the color-tone correction unit 32 and the preprocessing digital filter correction unit 33. FIG. 4 is a diagram illustrating an example of correction data stored in a storage in the inspection device according to the first embodiment. The correction data 24 is provided for each product and process, and includes, for example, a data number, a name, a sequence number, various parameters, and information on a preprocessing digital filter to be applied.

The data number and the name are information used for management of image correction. In the example illustrated in FIG. 4, correction by a color correction 61 and a preprocessing digital filter 81 is referred to as image correction 41. Correction by a color correction 62 and a preprocessing digital filter 82 is referred to as image correction 42. Correction by a color correction 63 and a preprocessing digital filter 83 is referred to as image correction 43. Correction by a color correction 64 and a preprocessing digital filter 84 is referred to as image correction 44.

The sequence number is information indicating the order of determining the determination image after image correction. The recognition unit 34 performs the two-dimensional code recognition in the order according to the sequence number attached to the image correction used at the time of generating each determination image. The sequence number is assigned to each image correction in ascending order from 1 for each product and process. In the example illustrated in FIG. 4, sequence numbers 1 to 4 are assigned to the image corrections 41, 42, 43, and 44 in this order.

The various parameters are information indicating a specific operation in the color correction performed in the color-tone correction unit 32 as parameters. The various parameters include, for example, amounts of change in respective values of RGB and HSV. The example illustrated in FIG. 4 includes the amounts of change in the respective values of RGB and HSV corresponding to the color corrections 61, 62, 63, and 64.

The preprocessing digital filter to be applied is information indicating the preprocessing digital filter applied by the preprocessing digital filter correction unit to the color-corrected image generated by applying the color correction. One preprocessing digital filter is associated with each color correction. The same preprocessing digital filter may be associated with different color corrections. The preprocessing digital filter is, for example, a preprocessing digital filter that performs at least one or more processing among image processing such as binarization, shrinkage, expansion, pixel value conversion, edge detection, smoothing, contour extraction, thinning, inversion, density correction, gamma correction, and arithmetic operation. A program for executing each preprocessing digital filter is stored in the control circuit 11 or the storage media 16.

The data included in the correction data 24 is determined based on a result of a statistical survey performed in advance. In the statistical survey, the success probability of two-dimensional code recognition of each color correction is calculated for each product and process. From the result of the statistical study, a plurality of image corrections in which the success probability of the two-dimensional code recognition is as high as possible is determined as a combination for each product and process, assigned with a data number and a name, and stored as correction data 24. At this time, the sequence numbers of the respective image corrections are assigned in ascending order from 1 to the probability, in descending order, of success in the two-dimensional code recognition using the determination image generated by applying the respective image corrections. The number of image corrections included in the correction data 24 is set such that, for example, in the two-dimensional code recognition processing, the probability that the two-dimensional code recognition will fail using all the generated determination images is the lowest when the processing time falls below a predetermined threshold.

The data included in the correction data 24 may be different for each product and process. The probability of success in the two-dimensional code recognition in a case where each correction is applied to the trimmed image may vary depending on the surface condition (frame, plating, resin, etc.) of the product on which the two-dimensional code is inscribed. Therefore, the color correction, the preprocessing digital filter, the combination thereof, and the sequence number of each image correction are determined such that the probability of success in the recognition of the two-dimensional code increases for each product and process that performs the two-dimensional code recognition.

### 1.2 Code Recognition Processing

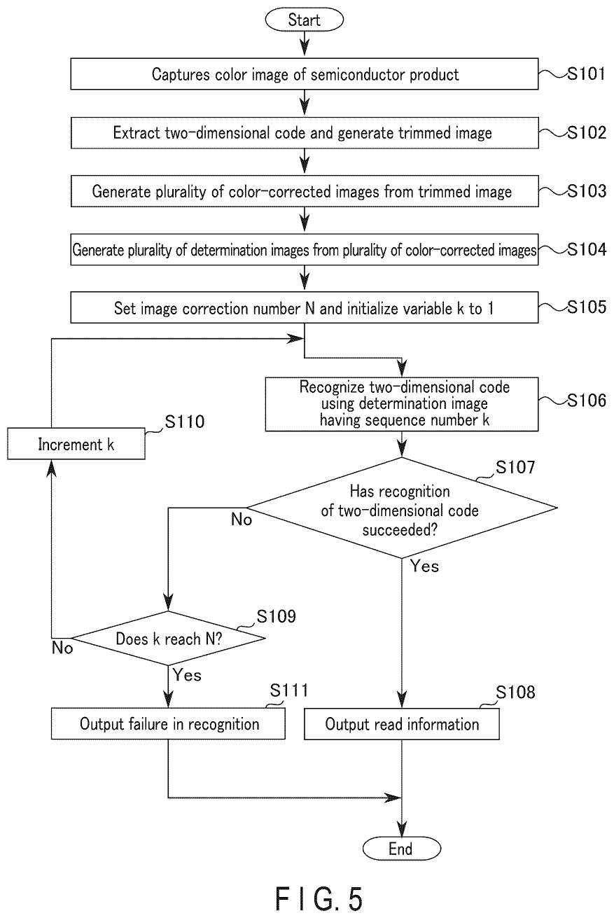

Code recognition processing according to the first embodiment will be described with reference to FIG. 5. FIG. 5 is a flowchart illustrating an example of code recognition processing according to the first embodiment. Hereinafter, an example of code recognition processing according to the first embodiment will be described with reference to FIG. 5 as appropriate.

When the target semiconductor product 100 is carried to the inspection position on the manufacturing line (Start), the imaging unit 21 captures a color image of the entire semiconductor product 100 including the two-dimensional code 200 (S101). The captured color image is sent to the appearance inspection module 22 and the code recognition module 23, and the appearance inspection and the two-dimensional code recognition are performed, respectively.

When the code recognition module 23 receives the color image from the imaging unit 21, the trimming unit 31 trims the color image to generate a trimmed image (S102). Specifically, first, a region including the two-dimensional code 200 in the color image is recognized. Feature point extraction or the like is used to recognize the region including the two-dimensional code 200. Thereafter, trimming is performed so as to extract the region including the two-dimensional code 200, and a trimmed image is generated.

Next, the code recognition module 23, in the color-tone correction unit 32, performs color correction on the trimmed image to generate a plurality of color-corrected images (S103). Specifically, first, various parameters for performing a plurality of color correction processing are read from the correction data 24. Thereafter, a plurality of color corrections are respectively applied to the trimmed image, and processing of the RGB ratio change, the HSV combination change, or both is performed to generate a plurality of color-corrected images.

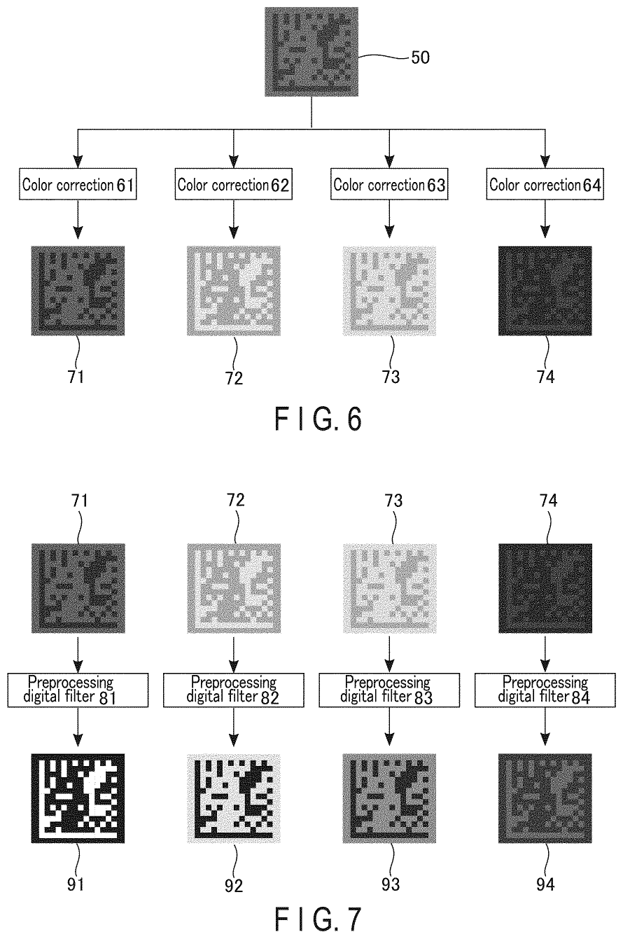

FIG. 6 is a diagram illustrating an example of a method of generating color-corrected images in the code recognition processing according to the first embodiment. In FIG. 6, the code recognition module 23 applies four color corrections 61, 62, 63, and 64 to the trimmed image 50 to generate color-corrected images 71, 72, 73, and 74. Note that the number of individual color corrections to be applied and the number of color-corrected images to be generated may be two or more.

Next, the code recognition module 23 performs preprocessing digital filter correction on each color-corrected image in the preprocessing digital filter correction unit 33 to generate a plurality of determination images (S104). Specifically, first, information on the preprocessing digital filter and the sequence number corresponding to the color correction used when each color-corrected image is generated is read from the correction data 24. Next, a program for executing each preprocessing digital filter stored in the control circuit 11 or the storage media 16 is read. Thereafter, each preprocessing digital filter is applied to the corresponding color-corrected image, and a plurality of determination images is generated. Each determination image is associated with a sequence number corresponding to each set of color correction and preprocessing digital filter correction.

FIG. 7 is a diagram illustrating an example of a method of generating determination images in the code recognition method according to the first embodiment. In FIG. 7, the code recognition module 23 applies the corresponding preprocessing digital filters 81, 82, 83, and 84 to the color-corrected images 71, 72, 73, and 74, respectively, to generate determination images 91, 92, 93, and 94. The determination images 91, 92, 93, and 94 are associated with sequence numbers 1, 2, 3, and 4, respectively.

Finally, the code recognition module 23 recognizes the two-dimensional code in the recognition unit 34, and outputs the recognition result to an external server (S105 to S111). Hereinafter, processing executed by the recognition unit 34 will be described in detail.

First, the recognition unit 34 sets an image correction number N stored in the correction data 24 from the number of determination images generated by the preprocessing digital filter correction unit 33. A variable k is initialized to 1 (S105). The image correction number N is an integer greater than or equal to 2. The variable k indicates a sequence number of the determination image for which image recognition is executed, and is an integer of 1 or more and N or less.

Next, the recognition unit 34 recognizes the two-dimensional code using the determination image having the sequence number k associated with the determination image (S106). Thereafter, it is determined whether or not the recognition of the two-dimensional code using the determination image having the sequence number k has succeeded (S107).

In a case where the two-dimensional code is successfully recognized (S107; Yes), the recognition unit 34 outputs the information read from the two-dimensional code to the server 2 (S108).

In a case where the recognition of the two-dimensional code fails (S107; No), the recognition unit 34 determines whether the variable k reaches the image correction number N (S109).

In a case where the variable k does not reach the image correction number N (S109; No), the recognition unit 34 increments k (S110).

After the processing of S110, the recognition unit 34 attempts to recognize the two-dimensional code using the determination image having the sequence number k (S106). In this manner, the processing of S106, S109, and S110 is repeatedly executed until the recognition of the two-dimensional code using the determination image having the sequence number k succeeds or the variable k reaches the image correction number N.

In a case where the variable k reaches the image correction number N (S109; Yes), a result indicating a failure in recognition of the two-dimensional code is output to the server 2 (S111).

After the processing of S108 or S111, the code recognition processing ends (End).

### 1.3 Effects According to First Embodiment

The code recognition method according to the first embodiment can perform highly accurate code recognition. This effect will be described in detail.

In the code recognition method according to the first embodiment, the code recognition module 23 performs color correction on the trimmed image to extract feature elements included in the trimmed image and recognize the two-dimensional code. Furthermore, in the extraction of the feature element, the code recognition module 23 generates a color-corrected image of a plurality of patterns in which RGB or a combination of HSV of the color image is changed, applies a preprocessing digital filter suitable for each color-corrected image, and performs two-dimensional code recognition processing. Through these processings, it is possible to recognize the two-dimensional code with a high accuracy without being affected by the material of the semiconductor product 100 to be inscribed with the two-dimensional code, the state of contamination or damage, noise caused by blurring, smearing, or the like at the time of imaging, dispersion of the imprint state (imprint depth, shape, color development, etc.) of the two-dimensional code 200, or the like.

In addition, the code recognition module 23 attempts to hierarchically recognize the two-dimensional code on the plurality of generated determination images in descending order of the prior probability of successful recognition. This increases the probability that recognition using the determination image to which image correction with a small sequence number is applied will succeed. In this case, the recognition processing using the determination image to which the image correction having the large sequence number is applied can be skipped, and the time can be reduced, so that efficient two-dimensional code recognition can be performed.

Each inspection device 1 incorporates an appearance inspection module 22 and a code recognition module 23. As a result, the code recognition module 23 can share, with the appearance inspection module 22, a highly accurate camera and processor used for performing the appearance inspection. As a result, since the appearance inspection processing and the code recognition processing can be performed by one inspection device 1, the cost and space can be reduced as compared with the case of individually manufacturing the appearance inspection device and the code recognition device.

### 1.4 Modifications

The code recognition method according to the first embodiment can be variously modified. Hereinafter, differences from the first embodiment will be described in some modifications of the first embodiment.

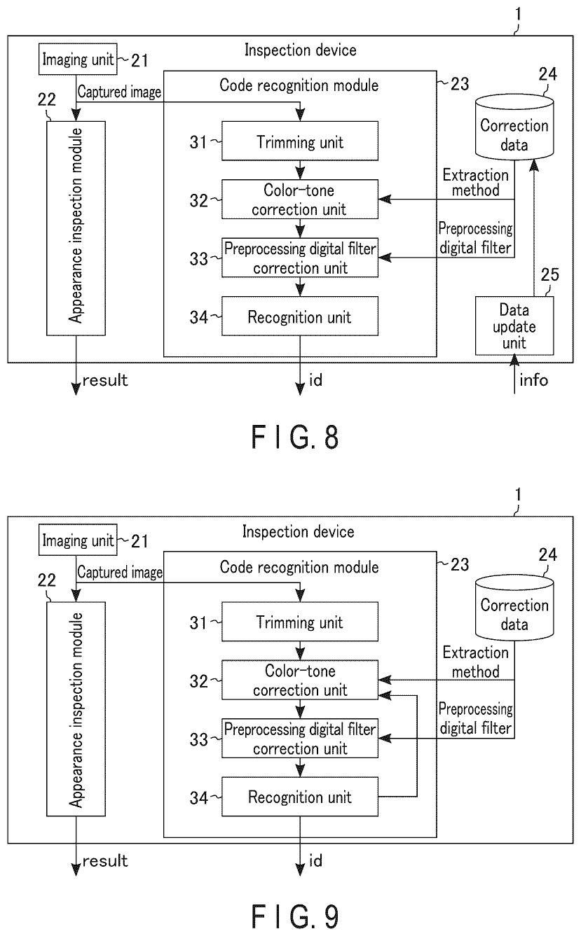

FIG. 8 is a block diagram illustrating an example of a functional configuration of an inspection device according to a first modification of the first embodiment. As illustrated in FIG. 8, the inspection device 1 according to the first modification of the first embodiment further includes a data update unit 25.

The data update unit 25 is a functional block that updates the correction data 24. The data update unit 25 receives information info from the outside. The information info includes information for updating the correction data 24 based on the state of the inspection device 1, the surface state of the semiconductor product 100 to be subjected to the code recognition, or the result of the performed code recognition. The data update unit 25 updates various parameters of each image correction stored in the correction data 24, the sequence number, or the preprocessing digital filter to be applied based on the information info.

With the configuration according to the first modification of the first embodiment, the code recognition method can be updated according to the change in the product state and the environment of the semiconductor product 100. As a result, even if the surface state or the degree of color development of the semiconductor product to be subjected to code recognition changes due to disturbance, the accuracy of code recognition can be maintained.

### 2. Second Embodiment

Next, a second embodiment will be described. Hereinafter, a configuration different from that of the first embodiment will be mainly described.

### 2.1 Configuration

FIG. 9 is a block diagram illustrating an example of a functional configuration of an inspection device according to a second embodiment. As illustrated in FIG. 9, in the code recognition module 23 according to the second embodiment, the recognition unit 34 can instruct the color-tone correction unit 32 to generate a color-corrected image.

### 2.2 Code Recognition Processing

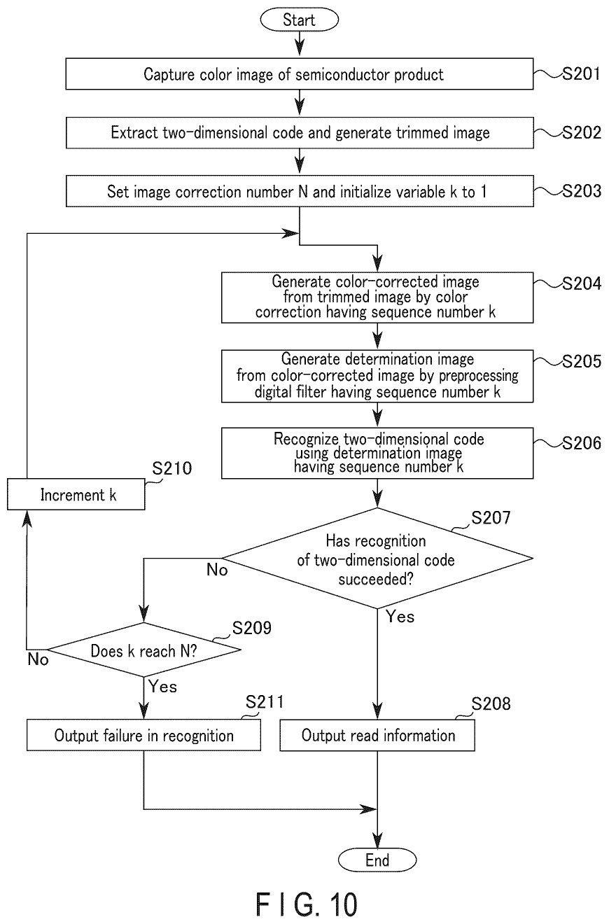

Code recognition processing according to the second embodiment will be described with reference to FIG. 10. FIG. 10 is a flowchart illustrating an example of code recognition processing according to the second embodiment. As illustrated in FIG. 10, the code recognition module 23 according to the second embodiment sequentially executes the processing of S201 to S211. Hereinafter, an example of code recognition processing of the code recognition module 23 according to the second embodiment will be described with appropriate reference to FIG. 10.

After the target semiconductor product 100 is transported to the inspection position on the manufacturing line (Start), the processes (S201 to S202) of capturing the color image and generating the trimmed image are similar to the processes (S101 to S102) of the first embodiment.

Next, the code recognition module 23 sets the image correction number N stored in the correction data 24. The variable k is initialized to 1 (S203). The image correction number N is an integer greater than or equal to 2. The variable k indicates a sequence number of the determination image for which image recognition is executed, and is an integer of 1 or more and N or less.

Next, the code recognition module 23 performs color correction on the trimmed image in the color-tone correction unit 32 to generate a color-corrected image (S204). Specifically, first, various parameters for performing the color correction processing corresponding to the image correction with the sequence number k are read from the correction data 24. Thereafter, the color correction is applied to the trimmed image, and processing of changing the RGB ratio, changing the HSV combination, or both is performed to generate a color-corrected image.

Next, the code recognition module 23 performs preprocessing digital filter correction on the color-corrected image in the preprocessing digital filter correction unit 33 to generate a determination image (S205). Specifically, first, the preprocessing digital filter corresponding to the image correction with the sequence number k is read from the correction data 24. Next, a program for executing each preprocessing digital filter stored in the control circuit 11 or the storage media 16 is read. Thereafter, the preprocessing digital filter is applied to the color-corrected image to generate a determination image.

Next, the recognition unit 34 recognizes the two-dimensional code using the determination image generated by the preprocessing digital filter correction unit 33 (S206). Thereafter, it is determined whether or not the two-dimensional code using the determination image has been successfully recognized (S207).

In a case where the two-dimensional code is successfully recognized (S207; Yes), the recognition unit 34 outputs the information read from the two-dimensional code to the server 2 (S208).

In a case where the recognition of the two-dimensional code fails (S207; No), the recognition unit 34 determines whether the variable k reaches the image correction number N (S209).

In a case where the variable k does not reach the image correction number N (S209; No), the recognition unit 34 increments k (S210).

After the processing of S210, the recognition unit 34 commands the color-tone correction unit 32 to generate a color-corrected image corresponding to image correction with the sequence number k. The color-tone correction unit 32 applies color correction corresponding to image correction with the sequence number k to the trimmed image to generate a color-corrected image (S204). As described above, the processing of S204 to S207 and S209 to S210 is repeatedly executed until the two-dimensional code using the determination image is successfully recognized or the variable k reaches the image correction number N.

In a case where the variable k reaches the image correction number N (S209; Yes), a result indicating a failure in recognition of the two-dimensional code is output to the server 2 (S211).

After the processing of S208 or S211, the code recognition processing ends (End).

### 2.3 Effects According to Second Embodiment

The code recognition method according to the second embodiment can perform highly accurate code recognition similarly to the first embodiment.

In the code recognition method according to the second embodiment, only in a case where the two-dimensional code recognition using one determination image fails is another determination image generated. Therefore, in a case where the recognition succeeds in the determination image to which the image correction with the smaller sequence number is applied, it is not necessary to generate the determination image to which the image correction with the larger sequence number is applied. Therefore, the time for generating the determination image can be shortened, and efficient two-dimensional code recognition can be performed.

### 2.4 Modifications

The code recognition method according to the second embodiment can be variously modified.

For example, as in the first modification of the first embodiment, a data update unit 25 may be further included as a functional block, and various parameters of each image correction stored in the correction data 24, a sequence number, or a preprocessing digital filter to be applied may be updated based on information info received from the outside. By using the code recognition method according to the present modification, the accuracy of code recognition can be maintained even if the surface state or the degree of color development of the semiconductor product to be subjected to code recognition changes due to disturbance.

### 3. Others

In the first and second embodiments, the method for recognizing the two-dimensional code inscribed on the semiconductor product has been described, but the object is not limited to the semiconductor product. The code recognition methods according to the first and second embodiments may be used, for example, for recognition of a two-dimensional code printed or inscribed on another electronic component, an electrical product, a machine, a tablet, a toy, a packaging of foods, an online image, or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A code recognition method comprising:
receiving a color image including a portion in which a code is inscribed;
generating a first image in which a first color correction is applied to the color image so as to change at least one of a ratio of RGB and a combination of HSV;
generating a second image in which a first preprocessing digital filter that performs preprocessing digital filter correction is applied to the first image;
generating a third image in which a second color correction different from the first color correction is applied to the color image so as to change at least one of a ratio of RGB or a combination of HSV;
generating a fourth image in which a second preprocessing digital filter that performs preprocessing digital filter correction is applied to the third image; and
performing recognition of the code using the second image and the fourth image.

2. The code recognition method according to claim 1, wherein
in a case where the recognition of the code using the second image fails,
the method executes recognition of the code using the fourth image.

3. The code recognition method according to claim 1, wherein
in a case where the recognition of the code using the second image fails, the method executes
generating the third image,
generating the fourth image, and
performing recognition of the code using the fourth image.

4. The code recognition method according to claim 1, further comprising:
determining the first preprocessing digital filter according to the first color correction; and
determining the second preprocessing digital filter according to the second color correction.

5. The code recognition method according to claim 1, wherein
the code has a square or rectangular shape having a side of 0.8 mm or more and 15 mm or less.

6. The code recognition method according to claim 5, wherein
the code is a symbol of Data Matrix.

7. The code recognition method according to claim 1, further comprising:
for any N (N is an integer greater than or equal to 3),
generating a (2k-1)-th image in which a k-th color correction (k is an integer satisfying 3≤k≤N) different from the first to (k-1)-th color corrections is applied to the color image so as to change at least one of a ratio of RGB and a combination of HSV;
generating a (2k)-th image in which a k-th preprocessing digital filter that performs preprocessing digital filter correction is applied to the (2k-1)-th image; and
performing code recognition using the second image, the fourth image, . . . , the (2N-2)-th image, and the (2N)-th image.

8. The code recognition method according to claim 7, wherein
the method executes recognition of the code using the (2k)-th image in a case where the recognition of the code using the (2k-2)-th image fails.

9. An inspection device comprising:
an imaging unit configured to capture a color image including a portion in which a code is inscribed; and
a code recognition module configured to recognize the code, wherein
a code recognition module including
a color-tone correction unit configured to generate a first image and a third image by applying a first color correction and a second color correction that change at least one of a ratio of RGB and a combination of HSV of the color image,
a preprocessing digital filter correction unit configured to generate a second image and a fourth image by applying first preprocessing digital filter correction and second preprocessing digital filter correction to the first image and the third image, respectively, and
a recognition unit configured to recognize the code using the second image and the fourth image.

10. The inspection device according to claim 9, wherein
the code recognition module further includes a trimming unit that extracts a portion in which the code is inscribed from the color image.

11. The inspection device according to claim 9, wherein
the recognition unit recognizes the code using the fourth image in a case where the recognition of the code using the second image fails.

12. The inspection device according to claim 9, wherein
in a case where the recognition unit fails to recognize the code using the second image,
the color-tone correction unit generates the third image by applying the second color correction to the color image,
the preprocessing digital filter correction unit generates the fourth image by applying the second preprocessing digital filter correction to the third image, and
the recognition unit recognizes the code using the fourth image.

13. The inspection device according to claim 9, wherein
the preprocessing digital filter correction unit
determines the first preprocessing digital filter according to the first color correction, and
determines the second preprocessing digital filter according to the second color correction.

14. The inspection device according to claim 9, wherein
the code has a square or rectangular shape having a side of 0.8 mm or more and 15 mm or less.

15. The inspection device according to claim 14, wherein
the code is a symbol of Data Matrix.

16. The inspection device according to claim 9, wherein
for any N (N is an integer greater than or equal to 3),
the color-tone correction unit further generates a (2k-1)-th image in which a k-th color correction (k is an integer satisfying 3≤k≤N) different from the first to (k-1)-th color corrections is applied to the color image so as to change at least one of a ratio of RGB and a combination of HSV,
the preprocessing digital filter correction unit further generates a (2k)-th image in which a k-th preprocessing digital filter that performs preprocessing digital filter correction is applied to the (2k-1)-th image, and
the recognition unit recognizes a code using the second image, the fourth image, . . . , the (2N-2)-th image, and the (2N)-th image.

17. The inspection device according to claim 16, wherein
the recognition unit executes recognition of the code using the (2k)-th image in a case where the recognition of the code using the (2k-2)-th image fails.

18. The inspection device according to claim 9, further comprising,
an appearance inspection module configured to receive the color image and inspect a presence or absence of abnormality of a product using an image generated by changing at least one of a ratio of RGB and a combination of HSV with respect to the color image.

19. A storage medium storing a program for causing a computer to execute,
receiving a color image including a portion in which a code is inscribed,
generating a first image in which a first color correction is applied to the color image so as to change at least one of a ratio of RGB and a combination of HSV,
generating a second image in which a first preprocessing digital filter that performs preprocessing digital filter correction is applied to the first image,
generating a third image in which a second color correction different from the first color correction is applied to the color image so as to change at least one of a ratio of RGB or a combination of HSV,
generating a fourth image in which a second preprocessing digital filter that performs preprocessing digital filter correction is applied to the third image,
performing recognition of the code using the second image, and
performing recognition of the code using the fourth image in a case where the recognition of the code using the second image fails.
